(19) United States
(12) Patent Application Publication
(10) Pub. No.: US 2021/0178930 A1
(43) Pub. Date: Jun. 17, 2021

(54) Combined Removable and Fixed Batteries in Powered Urban Mobility

(71) Applicant: Miniasec Mobility-Fabricacão de veiculos Automóveis de Mobilidade Urbana, S.A., Achete Santarém (PT)

(72) Inventors: António da Nóbrega de Sousa da Câmara, Lisbon (PT); Edmundo Manuel Nabais Nobre, Lisbon (PT); Cesar Manuel de Castro Guimarães Lopes, Sintra (PT); Tiago Vilares da Costa Carita, Lisbon (PT); André Esteves Gomes da Costa, Pragal (PT); Afonso Gouveia O'Neill, Lisbon (PT)

(21) Appl. No.: 17/124,939

(22) Filed: Dec. 17, 2020

Related U.S. Application Data
(60) Provisional application No. 62/948,976, filed on Dec. 17, 2019.

(51) Int. Cl. B60L 58/18; B60L 50/60; B60L 53/64; B60L 53/65; B60P 3/073; G07C 5/08

(52) U.S. Cl. CPC B60L 58/18; B60L 50/66; G07C 5/085; B60L 53/65; B60P 3/073; B60L 53/64

(57) ABSTRACT

A multimodal passenger transportation apparatus having a passenger electric, combustion or hybrid electric/combustion vehicle. Encased within the passenger vehicle (main vehicle) is another smaller vehicle (micro-vehicle) that can be driven by an electric motor. The micro-vehicle can be secured in the main vehicle for travel and detached for autonomous use. The micro-vehicle contains within itself a part of the main vehicle's battery that can be used to power its electric engine and can be charged independently. Once charged, the micro-vehicle can be reinserted back into the main vehicle, at which point both batteries work as one powering the main vehicle's engine. The battery packs are managed by a software system that allows energy to be allocated towards one vehicle's pack or the other, as desired. The micro-vehicle addresses a problem of lack of charging points near high density living areas, where people with no building parking areas have no access to charge his/her own vehicle from home or if no outside parking area has charging point.

### CROSS-REFERENCE TO RELATED APPLICATIONS

The present patent application incorporates by reference for all purposes the non-provisional U.S. patent application No. 62/948,976 filed on Dec. 17, 2019.

### TECHNICAL FIELD

The present invention is in the field of electric and/or hybrid powered urban mobility with rechargeable, removable and transportable battery packs.

### BACKGROUND OF THE INVENTION

Be it because of environmental regulations in city centers, ease of maneuverability of smaller vehicles in high-traffic areas, the development of sharing platforms or the high cost of fossil fuels (i.e. diesel and gasoline), electric urban vehicle use is growing rapidly, as is the variety of electric vehicles.

All these electrical means of transport are powered by rechargeable batteries. Typically, these batteries are arranged as packs of multiple individual rechargeable cells. These packs of cells are usually contained, semi-permanently, in a battery pack case within the vehicle. Owing to weight restrictions, and/or complex procedures, removable batteries, for off-vehicle charging, are less frequently used.

Current charging solutions involve navigating to charging stations, which are still scarce and where plugin times, for a minimum charge, are frequently upward of 30 minutes, even with fast-charging technologies; travelling to facilities where large mechanical hydraulic equipment is used to swap heavy batteries; or, as in the case of vehicle sharing networks, crews roam the city swapping batteries or transporting whole vehicles in order to charge them at central stations.

Nevertheless, swapping an empty battery for a charged one, for off-vehicle recharging of the former, is a procedure that extends autonomy and increases vehicle and operational flexibility. This is especially true if the electric vehicle is powered by more than one battery pack, where at least one such pack is removable. Removable and dual battery packs in vehicles are not new, patents for such systems are manyfold and exist at least since the 1980's.

Thus far, this recharging method has been merely transactional, i.e. a depleted battery pack is swapped for a fully charged one. This presents an opportunity to develop alternative swapping methodologies and intermediate uses for batteries packs, especially in vehicles powered by more than one unit, where one such unit may be removed, employed to power another device and independently recharged. Such a system simplifies and furthers the usefulness of the recharging procedure and reduces the overall weight a user would have to handle.

### SUMMARY

A vehicle where one of the encased battery packs is removable, for off-vehicle charging, and is in itself a means of transportation. The system allows recharging the main vehicle's pack using the secondary micro-vehicle as a removable easy-to-transport battery.

This describes a two-vehicle combination, where a main vehicle with an electrical motor allows the integration of a secondary micro-vehicle (FIG. 1 & FIG. 2). For that purpose, the main vehicle has a dedicated case space for the second vehicle.

When combined, the secondary vehicle becomes part of the main vehicle and the batteries of both vehicles become connected. When connected, the main vehicle will be able to use the energy from both batteries (its own battery and the secondary vehicle's pack).

Both vehicles can work autonomously using their own battery pack but, when combined, the main vehicle's autonomy increases with the contribution of the secondary vehicle's battery.

The apparatus has a management system to balance the energy between both vehicles' batteries based on selected profiles/configuration, but the user can override any of the decisions; basically it would be on two main decision lines: a) to recharge the main vehicle battery with the secondary micro-vehicle's pack or, b) to move the energy to the secondary vehicle's battery to get extra mobility and autonomy with the micro-vehicle.

This management system is part of the overall vehicle management software that also collects and shares data about and between the two vehicles.

### BRIEF DESCRIPTION OF THE DRAWINGS

FIG. 1 shows the main vehicle (1) and the micro-vehicle (2).

FIG. 2 shows the main vehicle (1), and the integrated micro-vehicle (2).

FIG. 3 shows the micro-vehicle's electric plug sockets.

FIG. 4 shows the data management software (1) gathering data from sensors and user inputs both from the main vehicle (4) and the micro-vehicle (2) and stored in a server (3).

FIG. 5 shows the main vehicle (1), the two battery packs connected sharing energy (2), the micro-vehicle's removable pack (3) and the main vehicle's battery pack (4).

FIG. 6 shows the different types of energy controller: Main Battery Manager (A), Auxiliary Battery Manager (B) and Super Cap Battery Manager (C); and the related sensor system (D).

FIG. 7 shows the Energy Management System and the process' it controls.

FIG. 8.1 is a flowchart that shows the energy process' of charging, expenditure and recharging relating with accelerating soft.

FIG. 8.2 is a flowchart that shows the energy process' of charging, expenditure and recharging relating with accelerating hard.

FIG. 8.3 is a flowchart that shows the energy process' of charging, expenditure and recharging relating with cruising.

FIG. 8.4 is a flowchart that shows the energy process' of charging, expenditure and recharging relating with braking.

FIG. 8.5 is a flowchart that shows the energy process' of charging, expenditure and recharging relating with idle in traffic.

FIG. 9 shows the selective power exchange system.

FIG. 10.1 is a flowchart that shows different states in the exchange manager: receiving energy

FIG. 10.2 is a flowchart that shows different states in the exchange manager: draining energy

FIG. 10.3 is a flowchart that shows different states in the exchange manager: idle usage

FIG. 11 shows the main vehicle (1) and the micro-vehicle/removable pack (2) in the process of detaching from the main vehicle, until fully independent.

FIG. 12 shows the micro-vehicle (electric scooter) with outline battery pack (1).

FIG. 13 shows the micro-vehicle (electric scooter) in the process of opening for user transportation.

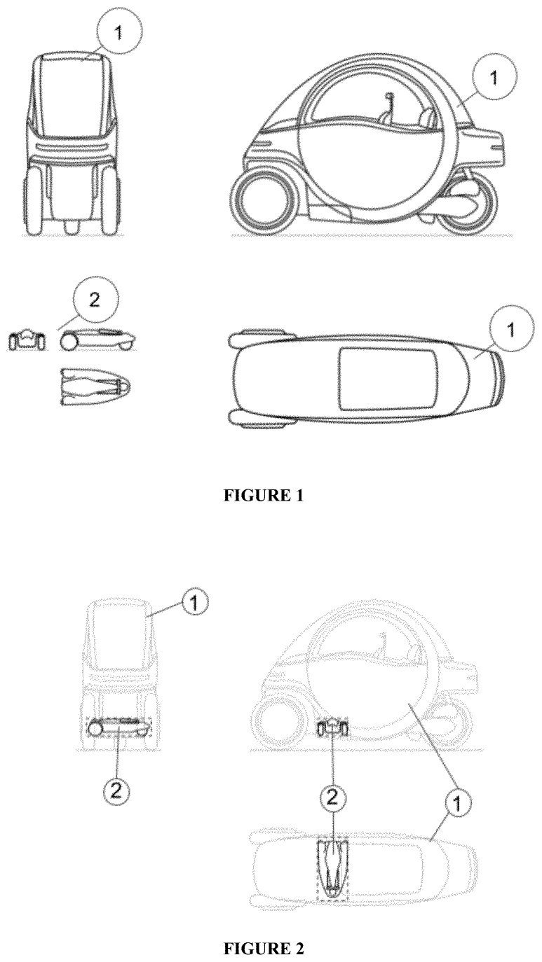

### DETAILED DESCRIPTION OF THE INVENTION

The detail drawings here disclosed are examples of possible embodiments of the invention. The invention may take various other alternative forms. Specific structural drawings are not to be seen as limiting but are merely demonstrative of how the invention may be embodied.

The Invention includes the following interconnected contributions:
A. Extended autonomy: full energy integration between connected vehicles
B. Extended knowledge: full data integration between connected vehicles
C. Energy balance management system
D. Detachable fractional battery
E. Drive the detachable battery

A) Extended Autonomy: Full Energy Integration Between Connected Vehicles

To extend the user's mobile autonomy by combining the main vehicle's battery with a secondary removable pack. This removable battery pack is itself part of a detachable, low-energy consumption micro-vehicle (2) integrated within the main vehicle (1). Aside from simplifying battery handling issues, this integrated micro-vehicle provides additional mobility and flexibility.

Urban mobility restrictions, such as environmental regulations, high-density traffic and insufficient parking mean that a driver may park at some distance from the destination and then use the micro-vehicle to reach the desired location. Hence, this micro-vehicle is often called “last-mile” vehicle.

This invention means that the micro-vehicle, in itself a battery pack ( ) may be driven to a charging point, be at home, office, or any other location where it can be fully charged, and then driven back to the main vehicle, where it will provide power to its electric engine and partially recharge the main battery.

In the preferred embodiment of the invention, a 3 wheeled electric vehicle (the main vehicle) has enclosed within it an electric micro-vehicle (an electric scooter, electric skate, electric hoverboard, or any other electric small device that can be used for human transportation). This electric micro-vehicle is also the removable battery pack. The main vehicle has a dedicated case from which the micro-vehicle/battery pack can slide in and out.

Connecting and disconnecting the micro-vehicle from the main vehicle is detailed as follows:

The alignment and solidity of storage of the micro-vehicle in the main vehicle and the action of coupling and uncoupling said vehicles is described as follows:

The micro-vehicle is inserted underneath the main vehicle's driver's seat, from the outside. A door opens to the micro-vehicle's compartment and this vehicle is then pushed inside. Perfect fitting alignment of the micro-vehicle within the main vehicle is ensured by 2 rails for each wheel (totaling 6 rails, 3 fixed and 3 mobile). Closing the door to this compartment further secures the micro-vehicle within the main vehicle, as this door is coated with anti-vibration rubber, (with a felt layer on top so as not to dent the micro-vehicle) and the mobile rails tightens the micro-vehicle's wheels.

In the preferred embodiment of the invention, the action of connecting and disconnecting the actual battery packs of the micro-vehicle and the main vehicle is described as follows:

The actual electric connection between the two vehicles is at the deep end of the main vehicle's storage compartment. This connection is composed of two conductive metallic spikes that penetrate the micro-vehicle at the front, between the wheels and the plastic panel, where the plug sockets are located. The perfect alignment guaranteed by the, previously described, wheel rails, which coupled with the compartment's tightness ensure that this connection is always successful and secure.

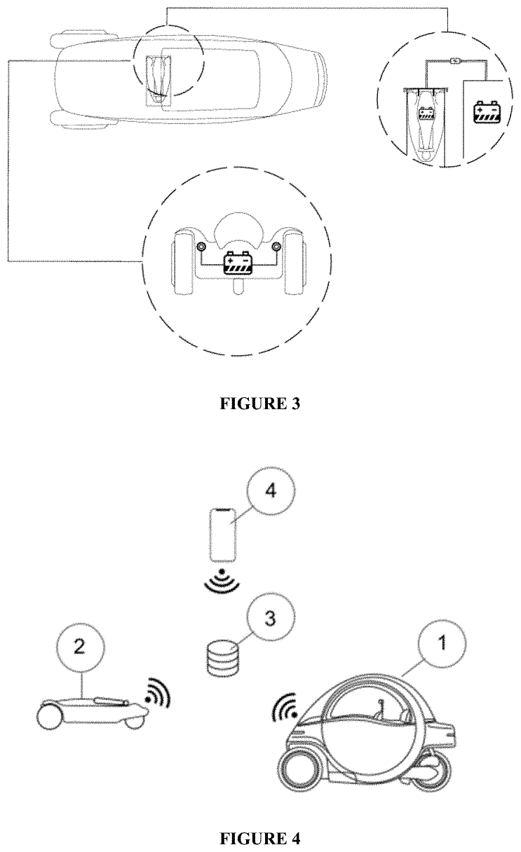

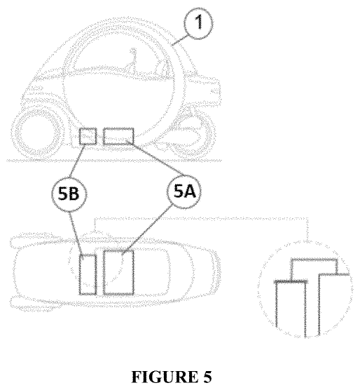

The micro-vehicle's electric plug sockets are based on the anti-shock socket system. The openings and mechanically shut with two plastic pins with a spring, once the main vehicle's metallic pins push through the socket plastic pins move sideways, allowing an electric connection (FIG. 3).

B) Extended Knowledge: Full Data Integration Between Connected Vehicles

When connected, by sharing data that both have collected, the two vehicles become part of the same intelligent management system. For reporting, planning or logbook tasks, the ability to share the data collected by both vehicles allows for a better understanding of the full activity and extends the users mobility autonomy by more effective management. The shared information comprises all sensory and driver input data that both vehicles are able to collect. This information includes, but is not limited to, vehicle status (energy and other components' sensors), driving modes (manual, autonomous), environmental information (several environmental sensors), image and video (captured from image sensors), paths and planning (GPS, compass, accelerometer sensors). All this information is stored locally on a “Blackbox” and can be acceded trough an application or published to online grids (ex: 5G lens).

For example, a driver wants to know the total distance he covered that week, decomposed by modality, the system has the data from both the micro-vehicle (2) and the main vehicle (1) and, once queried, the server (3) returns the integrated and decomposed values that can be visualized on the smartphone (4).

C) Energy Balance Management System

Both the main vehicle and the micro-vehicle can function independently, this also means that their battery packs are able to be charged independently. Once coupled together, both battery packs function symbiotically, i.e. energy may be transferred between them and optimized in predefined profiles. This flow of energy is automatically with the possibility of user override, by the energy balance management system. Through this system, the system prioritizes which battery pack is on the energy receiving or draining end and set the balance of energy between the two battery packs. The driver can decide where to concentrate the energy: a) to recharge the main vehicle's cell (5A) with the secondary micro-vehicle's battery (5B), b) to move the energy to the secondary vehicle's battery to get extra mobility and autonomy with the micro-vehicle or c) to define a fixed percentage distribution between both packs.

An example of this activity, a driver parks the same 3 wheeled electric vehicle somewhere in the city, he is still 2 km away from the final destination. He had already planned his drive from start to finish on the navigation device. The driver pulls out the electric micro-vehicle (for example, an electric scooter) and completes his journey riding it. The management system has calculated the distance from the parked main vehicle to the journey's end and, if necessary, has endowed the micro-vehicle with enough energy to allow the completion of the journey. This same procedure may also be conducted manually.

Generic Hardware System

The energy management methodology is composed by a management system for storage, consumption, charging, recovery, balancing and energy transferring.

Important rules in energy storage advise that battery cycles should be kept to a minimum; full charging and discharging cycles should be attempted; temperature fluctuations should be minimized, and micro charging should be reduced. With these rules in mind the following energy management system was developed:

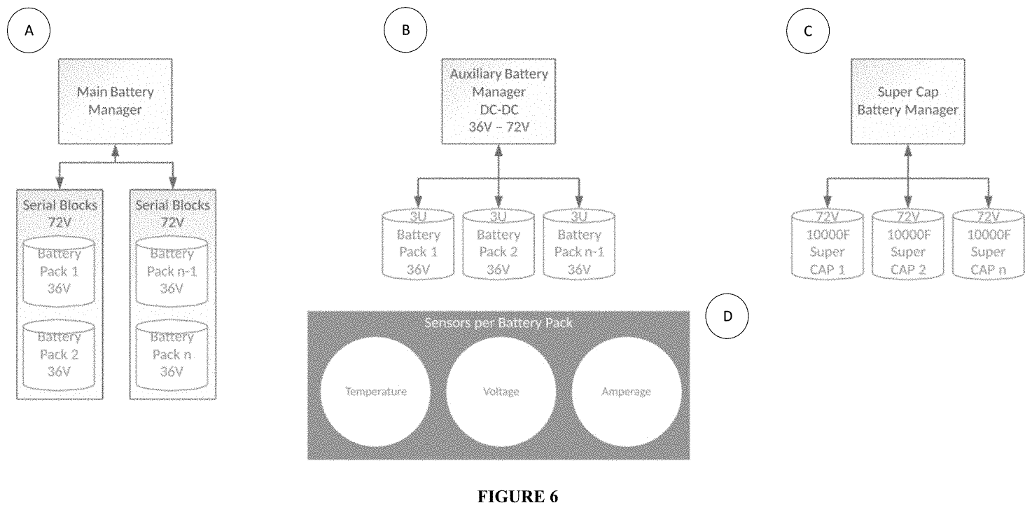

Three different types of energy controller and a sensor manager, with distinct functions, were designed to manage all sorts of energy storage:
Main Battery Manager (FIG. 6A)—the principal batteries of the main vehicle, a series of 72V (42 Ah) lithium battery blocks—the purpose of this system is to supply energy to the main vehicle, whenever necessary, uniformly charge and discharge the cells and protect them from excessive current and under voltages and extreme temperatures;
Auxiliary Battery Manager (FIG. 6B)—this module is only active if the micro-vehicle is connected with the main vehicle. In which case it will have the same behavior as the Main Battery Manager and the same functions;
Super Cap Battery Manager (FIG. 6C)—this module is the block that protects all the batteries from quick charges or discharges. It is also responsible for receiving energy from the regenerative braking system or from the combustion engine. It has all the sensorial functions as the Main Battery Manager with the exception of temperature control or power cut;
Sensors Manager (FIG. 6D)—in order to control everything, the first two systems are both equipped with sensors, for each battery block, measuring voltage, power and temperature.

Note: none of the described systems decides whether to charge or discharge, they are simply permanently available for both situations. None of the systems exchanges energy without the control of the Energy Management Module.

Energy Management Behavior System

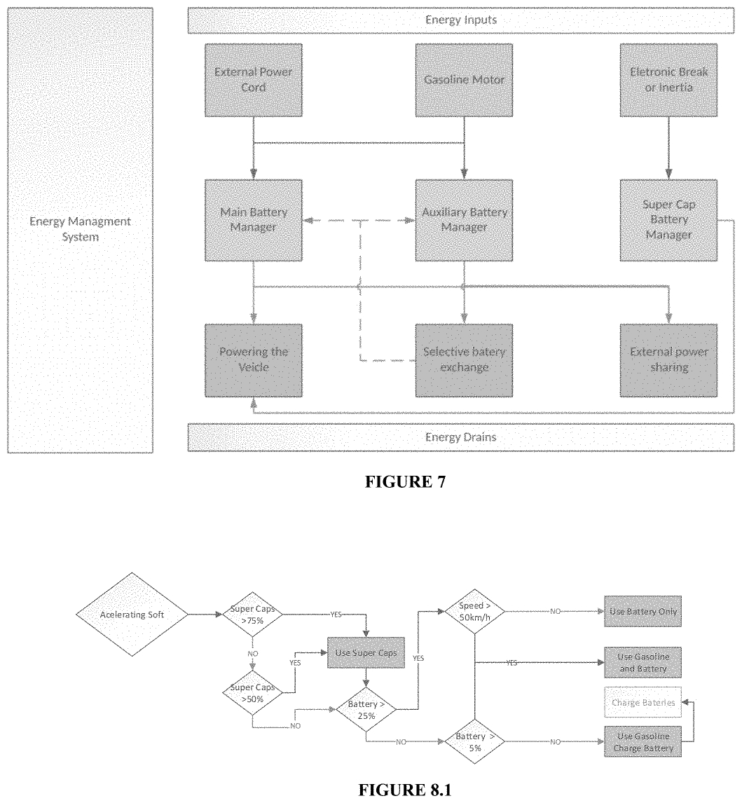

All controller modules are coordinated by the Energy Management System (FIG. 7). This system's function is to manage how energy is employed and recharged.

In this case, the main battery, together with the auxiliary batteries (if available), are recharging when the vehicle is plugged into a power source or running the combustion engine. This recharging is continuous and help maintain a good energy supply; there will always be an energy management software that may rollover the recharging cycle if the batteries are too hot or have been recharged very recently.

Super Caps are employed to draw energy from inertia and braking and can help power amperage spikes without straining the batteries.

The Selective Battery Exchange system is a semi-automatic or manual process that allows a forced energy exchange between the Main Battery Manager and the Auxiliary Battery Manager.

All the mentioned systems communicate via CAN BUS, which the industry's standard, notwithstanding the fact that the Energy Management System is the overall coordinator of all vehicle systems, operating semi-independently and autonomously from all other systems.

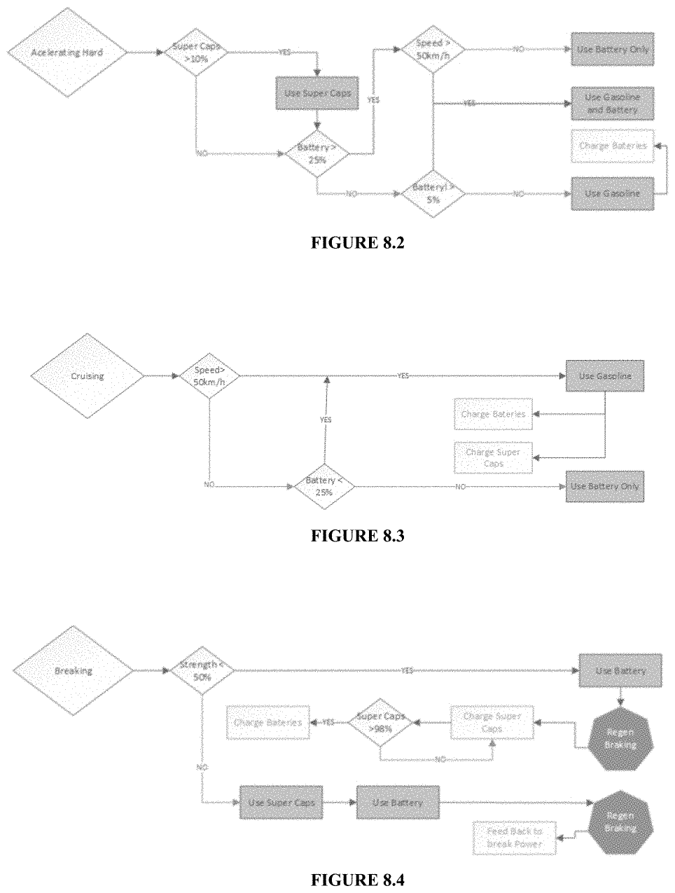

The main available behaviors in the energy management system are the following: Accelerating Soft (FIG. 8.1), Accelerating Hard (FIG. 8.2), Cruising (FIG. 8.3), Breaking (FIG. 8.4) and (Idle in traffic—very low speed (FIG. 8.5)

Selective Power Exchange System:

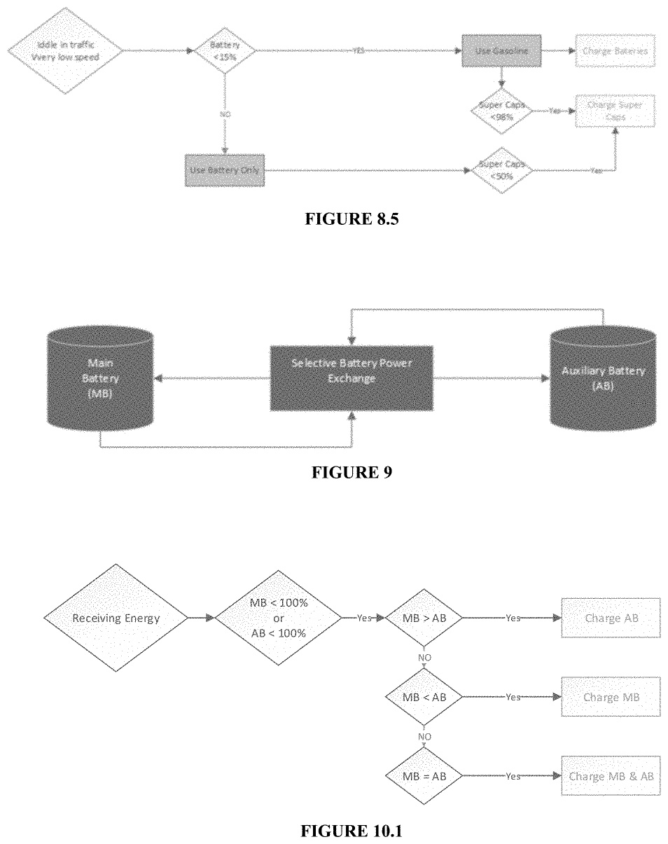

The system regulates drain and charge and balancing between the Main Battery and auxiliary battery (FIG. 9). This main control system will check several configurable conditions and act accordingly.

Energy Exchange Manager Stages

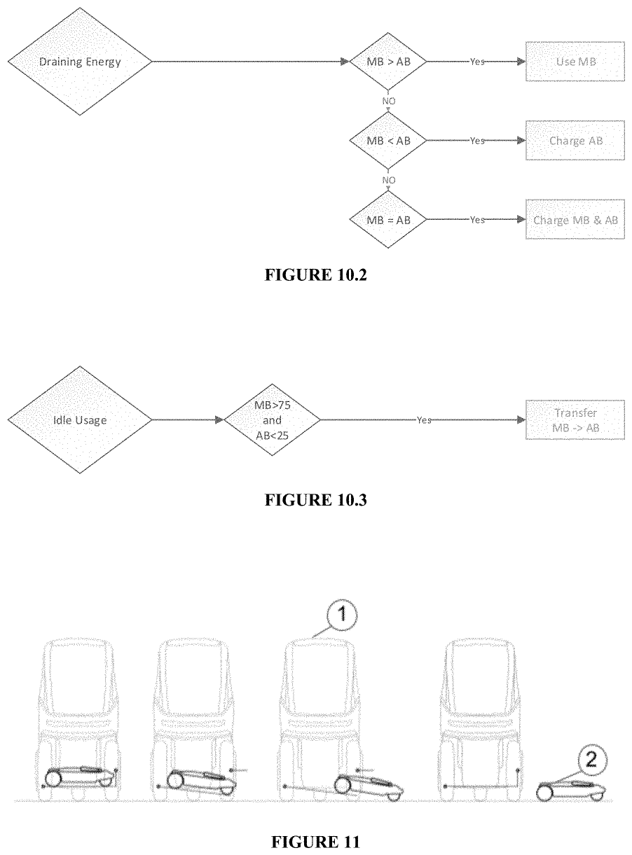

3 main states in the exchange manager are considered: a) Receiving Energy, where we have to account of the differences between batteries and feed each other correctly to the needs unless user specified different behavior's (FIG. 10.1); b) Draining Energy, where the system decides which battery to drain first under the standard needs except if users specified (FIG. 10.2) and; c) Idle Usage, or in idle mode if one battery in too low (below a standard threshold unless user specification) if it can be balanced with the other or not (FIG. 10.3).

D) Detachable Fractional Battery

The ability to detach a fraction of the main vehicle's battery (depending on the implemented solution, can range from 0% to 100%) and make it mobile to facilitate the transportation and recharging operation.

This disclosure refers to a main electric vehicle (1) and to a secondary micro-vehicle (2) that can be secured within the main vehicle for safe travel and energy sharing, and then detached when needed. However, the invention may also be embodied as a combustion or hybrid electric/combustion vehicle, wherein any given part of the battery is stowed and can be released for off-vehicle recharging. This recharging operation is simplified as the removable battery is encased within another mobility device that aids in its transportation. This micro-vehicle may or may not be powered by the battery cell that it carries.

A user may ask that the battery ratio between main and secondary vehicles be personalized to the user's needs. Say a driver has restricted parking in her neighborhood and has a parking spot 1 km away from her home, this parking spot, however, has no electric charging options. The user may ask for her vehicles to have a main/secondary battery ratio adapted to this circumstance—most of the battery capacity be installed on the removable pack so it may be easily recharged at home and plugged back into the main vehicle the next morning.

E) Drive the Detachable Battery

The ability to use the detachable battery to power a micro-vehicle that the user can ride: users need not carry the battery pack anymore; the battery can carry a user.

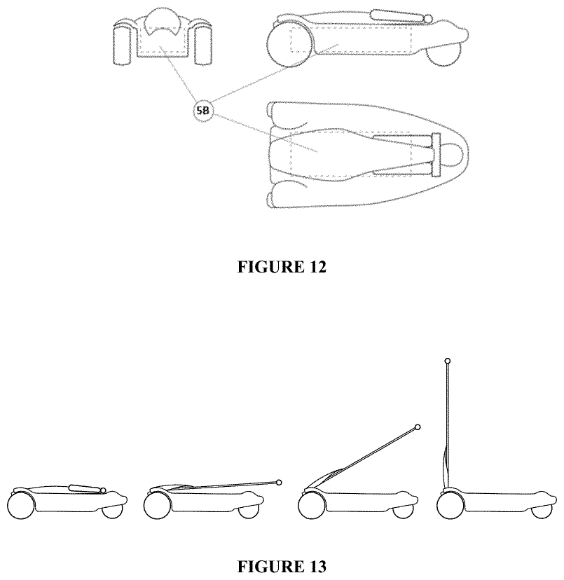

Portable batteries are not a novelty. There are already several electric mobility solutions involving the ability to remove the battery and carry it to a charging point. Nevertheless, the existing solutions are usually not suitable to cover long distances (over 20 meters) as battery packs are usually heavy and need to be carried by hand (even if there are wheeled carry-ons to facilitate transportation). In the system here disclosed, the user does not simply carry the removable battery. In fact, in this case, the battery carries the user himself When removed from the vehicle, the battery (FIGS. 11 and 12) assumes the configuration of a micro-vehicle (2) capable of transporting the user to the charging point in a much faster and easier way.

For example, a driver parks his 3 wheeled electric car 2 km from his final destination, say a beach with restricted car access, he detaches the electric scooter, which is part of the main vehicle battery system, and drives it the rest of the distance. Once there, he can plug the scooter at any power outlet, charge the battery while having lunch, return to the parked car, slide the scooter/battery back into the vehicle securing it for travel. The 3 wheeled electric vehicle has now increased its autonomy because part of its battery has been recharged elsewhere.

### RELATED PATENTS

1. United States Patent Application 20180111540 “Vehicle with an integrated electric motorcycle”;
2. U.S. Pat. No. 4,564,797 “Battery management system”;
3. U.S. Pat. No. 4,450,400 “Battery replacement system for electric vehicles”;
4. U.S. Pat. No. 8,852,794 “Electric vehicle battery case”;
5. U.S. Pat. No. 5,760,569 “Replaceable battery module for electric vehicle”;
6. United States Patent Application 20100213898 “Motive power dual battery pack”;
7. United States Application US20110226539 “Vehicle with removable auxiliary power system”;
8. U.S. Pat. No. 9,421,872 “Vehicle and battery pack”;
9. U.S. Pat. No. 8,013,611 “Vehicle battery product and battery monitoring system”;
10. United States Patent Application 20140265554 “Dual Lithium-Ion Battery System for Electric Vehicles”;
11. United States Patent Application 20190016231 “Electric Vehicle With Modular Removable Auxiliary Battery With Integrated Cooling”;
12. U.S. Pat. No. 10,351,010 “Battery system for vehicle”;
13. U.S. Pat. No. 8,517,132 “Electric vehicle battery system”;
14. United States Patent Application 20110226539 “VEHICLE WITH REMOVABLE AUXILIARY POWER SYSTEM”;
15. United States Patent Application 20150331472 “DUAL POWER SUPPLY SYSTEM AND ELECTRICALLY DRIVEN VEHICLE”

### REFERENCE NUMBERS

1. Main vehicle
2. Micro vehicle
3. Server
4. Data management software
5A. Main vehicle's battery pack
5B. Micro vehicle's battery pack

1. A multiple electric vehicle combination comprising:
a main electric vehicle, and at least one electric micro-vehicle, wherein the at least one electric micro-vehicle is enclosed within the main electric vehicle,
wherein the main electric vehicle shares the same battery system with the at least one electric micro-vehicle,
wherein the main electric vehicle comprises a dedicated case from which the electric micro-vehicle is configured to slide in and out by connecting and disconnecting means,
wherein the main electric vehicle comprises a first battery pack and the electric micro-vehicle comprises a removable rechargeable second battery pack,
wherein the first battery pack and the second battery pack are fully integrated and adapted to function symbiotically.

2. The multiple electric vehicle combination of claim 1, wherein the first battery pack and the second battery pack are configured to be charged independently or when connected, and
wherein, when connected, the energy may be transferred between the first battery pack and the second battery pack and optimized in predefined default profile and user configurable profiles.

3. An energy balance management system comprising
a hardware system comprising:
Main Battery Manager of generic lithium battery blocks with voltage, current and temperature protection system;
Auxiliary Battery Manager to oversee the number of compatible connected batteries with voltage, current and temperature protection system;
Super Cap Battery Manager to manage a group of supper capacitors and to recover kinetic and break energy; and
Sensors Manager to compiles and monitors the hardware system;
a software system, comprising:
Selective Power Exchange System for storage, consumption, charging, recovery, balancing and energy transferring; and
Profile Manager containing predefined default profile and user configurable profiles;
wherein the energy balance management system manages the energy balance between the battery packs of the integrated electric vehicles to decide which battery will have the priority to accumulate or spend the remaining energy.

4. A computer-implemented method for managing the balance energy in the multiple electric vehicle combination disclosed in claim 1 comprising:
providing an energy balance management system disclosed in claim 3; and
managing the energy balance between the battery packs of the integrated electric vehicles to decide which battery will have the priority to accumulate or spend the remaining energy.

5. A computer program configured to implement the computer-implemented method of claim 4, wherein the computer program is configured to be executed on a processor.

6. A computer program for executing the method for managing the balance energy in the multiple electric vehicle combination comprising
instructions for connecting and sharing the data captured and compiled between all connected electric vehicles of the multiple electric vehicle combination of claim 1;
instructions for storing the information locally on a “Blackbox”; and
instructions for publishing the information to online grids.
